(19) United States
(12) Patent Application Publication
(10) Pub. No.: US 2024/0391747 A1
(43) Pub. Date: Nov. 28, 2024

(54) LUGGAGE LIFTER

(71) Applicant: Susan Leeds Lieff, Pacific Palisades, CA (US)

(72) Inventor: Susan Leeds Lieff, Pacific Palisades, CA (US)

(21) Appl. No.: 18/200,558

(22) Filed: May 22, 2023

(51) Int. Cl. B66F 19/00

(52) U.S. Cl. CPC B66F 19/00; B64D 11/003

(57) ABSTRACT

An apparatus that allows lifting carry-on luggage into place in a passenger aircraft overhead compartment quickly and with ease. A heavy-duty carbon nanotube yarn torsion spring is rewound into a highly energized state. At the time of use, the energy and force of the carbon nanotube yarn torsion spring is released, raising a heavy carry-on luggage piece up to the level of the overhead compartment, when it is pushed into the overhead compartment. At the destination, the luggage lifter is reversed, allowing for most of the carbon nanotube yarn torsion spring to be rewound as the luggage descends to the aircraft floor. The luggage lifter may be used as attachable to a luggage piece by means of a harness or it may be built into a luggage piece.

### FIELD OF THE INVENTION

This invention relates to a method and apparatus for lifting heavy luggage into the carry-on upper luggage compartments on commercial airplanes,

This invention relates to a method and apparatus for lightweight portable hoists.

### BACKGROUND OF THE INVENTION

Typical portable hoists weight 20 lbs. or more, and typically require a source for 110 volts AC. However, for a traveler who needs to lift a heavy carryon baggage into an overhead compartment, a much more lightweight hoist, which operates independently of a 110 volt (or, 220 volt) AC plug, would be very useful.

### SUMMARY

The portable luggage lifter hoist has a two-phase operation. In the first phase a small battery-operated motor, acting thru a gearbox, torsions one or more torsion springs. In the second phase, when an object is to be lifted or hoisted, a switch disengages the motor and releases the torsion spring (or springs), which then operate a rotating cylinder which moves a webbing, since the rotating cylinder is backed by a free rolling cylinder. The webbing has a hook-like device at one end which hooks onto the lip of an overhead compartment, while the portable luggage lifter hoist attaches to the luggage piece to be lifted by an attachment means.

The battery for the luggage lifter is typically an lithium ion battery such as a lithium phosphate based battery. The battery is chargeable, typically, via a USB connection, to an appropriate transformer, which may be charge from a standard 110-volt power-source, at a time of the traveler's convenience.

The battery, with an appropriate transformer, can also be recharged from a 220-volt source, for example. The hoist may be accompanied by a second battery, which is pluggable into the hoist motor-gear section, as a replaceable battery, while a first battery is being recharged.

When the torsion spring is being wound up to store energy in it, a ratchet mechanism prevents the torsion spring from unwinding and releasing energy at any time other than when spring power is needed for lifting. A suitable torsion spring is one made of a yarn of carbon nanotubes.

A switch is set to keep the retaining ratchet in place until lifting is desired. The switch then is moved to a second position which pushes the retaining ratchet out of the way such that the power of the torsion spring.

A suitable gearbox, preferably constructed from light-weight materials, such as aluminum, or a suitable plastic is used to ‘gear up’ the small torque produced by the battery-operated motor, so as to provide sufficient energy.

The small battery-operated motor must be ‘geared-up’ to produce the necessary toque to power the lifting operation. However, this results in a slow movement on the output of the motor's operation directly. However, by pre-charging the torsion spring, the energy stored can be released in a controlled, but much faster, manner, suitable for timely lifting a carry-on luggage up to the level of an overhead compartment.

When unloading the luggage from the overhead compartment, the luggage piece can be attached to the hoist and the lip of the overhead compartment. Preferentially, the luggage lifter may be kept attached to the luggage piece and only the hook-like means attaching to the lip of the overhead luggage compartment is removed to facilitate the closing of the overhead compartment. At the traveler's destination, the hook is reattached to the lip of the overhead compartment and the luggage is allowed to descend with the luggage, all the time rewinding the torsion spring, at least to a high percentage of its initial power. This allows a second use without recharging, or at most, a much reduced time and power requirement for winding the torsion spring to its maximum power storage.

### BRIEF DESCRIPTION OF THE DRAWINGS

The luggage lifter may be used as a stand-alone item or it may be built into a luggage piece.

The accompanying drawings, which are incorporated in and constitute a part of this specification exemplify embodiments of the present invention and, together with the description, serve to explain and illustrate principles of the inventive technique. Specifically:

FIG. 1 shows the components of the luggage lift system in block form;

FIG. 2 illustrates the luggage lifter sub-assembly for operating the web which will attach to the airplane carry-on luggage compartment with a spring mechanism and a web roller driver cylinder and a passive roller cylinder;

FIG. 3 depicts the reduction gear box and its placement with a small battery operated motor

FIG. 4 shows rechargeable battery, motor and the worm gear;

FIG. 5 shows the operation of the ratchet and pawl, as the small motor winds up the carbon fiber yarn torsion spring, together with a releasing and a setting device for engaging and disengaging the pawl and ratchet gear;

FIG. 6 indicates the attachment of the luggage lifter relative to a passenger aircraft's overhead compartment (not part of this invention), the luggage on the luggage lifter's harness, and the luggage lifter active mechanism of removeable battery, gearbox and web roller driving cylinders;

FIG. 7A illustrates a mechanical activation device for the luggage lifter;

FIG. 7B illustrates an electrical activation deice for the luggage lifter.

FIG. 8 shows the luggage lifter as built into a luggage piece.

### DETAILED DESCRIPTION OF PREFERRED EMBODIMENTS

The following description is of preferred embodiments contemplated for carrying out this invention. This description is not to be taken in a limiting sense, but is made for the purpose of describing the general principles of the invention.

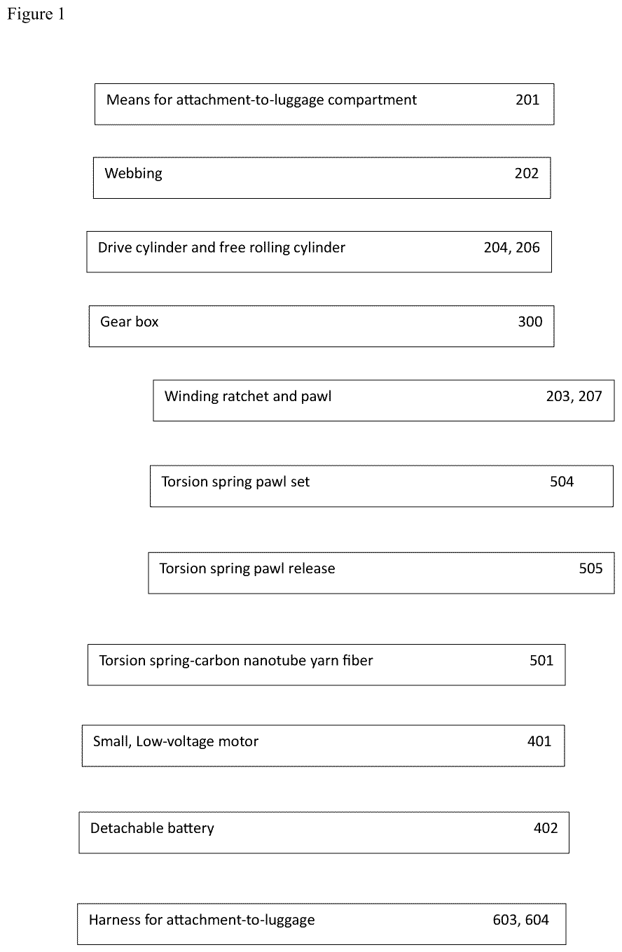

FIG. 1 is a block diagram for a listing of the components of a preferred embodiment of the luggage lifter. Included are a means for attaching 201 the remote part of the luggage lifter to an open overhead compartment 600 (not part of this invention) of a passenger aircraft. Such means include a hook 601 which will hook over the lip of an overhead compartment. The hook 101 is connected to a webbing 202 which descends down to a drive cylinder 204 and a passive rolling cylinder 206. The drive cylinder 204 is attached to a gearbox 300 which reduces the rotation rate of a small battery 402 operated motor 402 and increases its effective torque. The luggage lifter is aimed at a maximum range of lifting 100 pounds a height of 6 feet, or equivalent (600 foot-pounds).

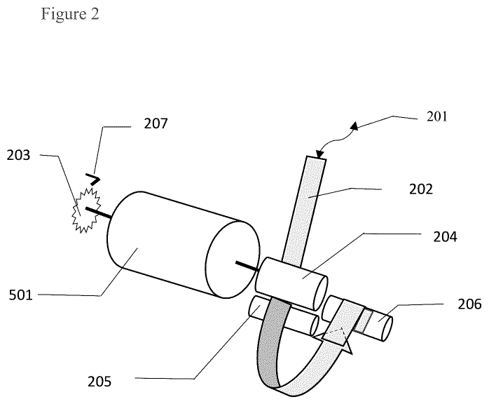

In order to accomplish this, FIG. 1 indicates in a block-style diagram, ta preferred embodiment such that hat a winding ratchet 203 and a pawl 207 are used to prevent a torsion spring 501 from unwinding while it is being tensioned under the action of a small battery 402 operated motor 402, by way of a gear box 300 and a pawl set 504 is used to engage the pawl 207 on a ratchet 203. When the luggage is to be lowered, the pawl release 505 disengages the pawl 207 from the winding ratchet 203 and the weight of the luggage slides the luggage down the webbing 202 and reverses the direction of the drive cylinder 204 which counter-rotates in the direction of winding up the torsion spring 501, to the extent allowed by frictional forces. Thus, the tendency is to rewind the torsion spring, 501 although not completely. The details are more fully described in the following FIGS. 2-7.

FIG. 2, in a preferred embodiment, starts with a detail where the winding power is entered at the winding ratchet 203 and pawl 207 driven in a one-way direction to a torsion spring 501 depicted here schematically. In order to achieve a timely released burst of power, the torsion spring 501 must be able to store enough energy and release it quickly enough, i.e., enough power, to quickly lift the weight of the luggage. To do this, a torsion ‘spring’501 is made of carbon nanotubes in the form of a yarn. Such a ‘spring’ 501 can supply 77200 kJ/m³ which translate to about 813 Joules (600 foot-ponds) per 100 cm³, or a length of 10 cm and a diameter of 4.5 cm, or equivalent combination. This is much beyond ordinary available metal torsion springs.

FIG. 2 also shows a preferred embodiment with a flat webbing 202 is driven by the torsion spring 501 by way of a drive cylinder 204 compressed against a passive roller 205. In another preferred embodiment (optional) a secondary wind-up roller 206, driven by light metal coil springs (not shown), may act as a take up roller. Otherwise, in a basic preferred embodiment, the hanging loose webbing 202 is merely taken by hand and placed within the open aircraft overhead compartment 600 (not part of the invention). When the lifting is completed, a hook 201 is detached from the lip of the overhead aircraft compartment 600 (not part of the invention) and placed with that compartment. Before lowering the luggage, the hook 201 is reattached to the lip of the aircraft overhead compartment 600.

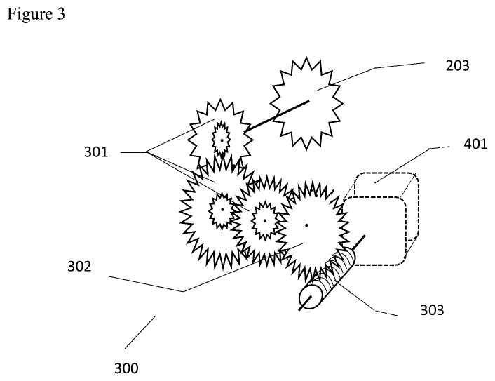

FIG. 3 mainly shows a preferred embodiment with gear box 300 for reducing the rotation rate of the small battery 402 operated motor 401, with a worm gear 303 and its worm-driven gear 302, as well as a number of gears 301 driven in a rotation rate reduction mode (i.e., in a torque multiplying mode). The directional ratchet 203 is shown without the pawl 207.

The particular gearbox 300 (of FIG. 3) specification will depend upon the particular motor 401 chosen. The overall reduction will be, for example, from 1, 296,000 rpm to 0.01 rpm by way of a 100:1 worm gear and then a 36:1 and a 36:1 reduction and a 10:1 reduction. Typical hobby motors may have 12500 to 25000 rpm and a torque of 10 gm-cm. A very slow winding with an ultimate burst of energy. Choosing a more robust motor, 401 will reduce the time to initially wind up the torsion spring 501.

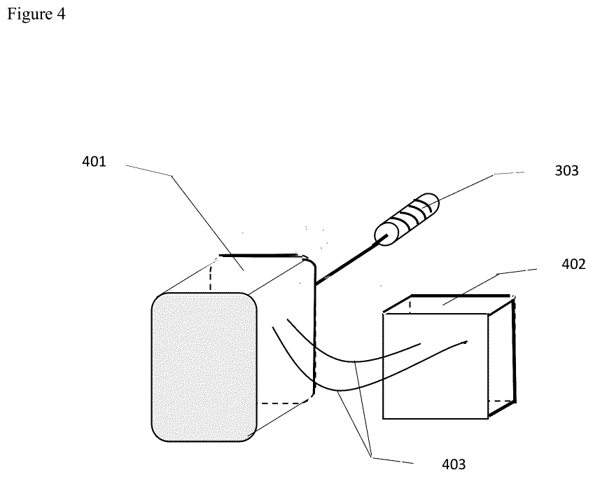

FIG. 4 shows the preferred embodiment of a motor 401, its battery 402, with connecting conductors 403 and also showing the motor 401 output shaft worm gear 303. A somewhat larger motor with a lower initial rpm but a higher torque can easily be specified. With a 24 volt battery supply, one can find commercial motors (as opposed to the hobby motors cited above) with torques in the range of 100s of foot pounds. The tradeoff is portability and price.

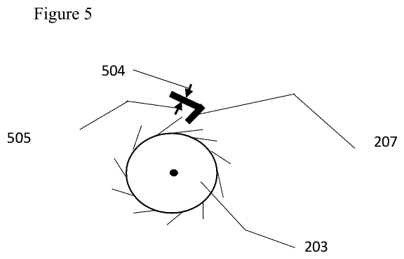

FIG. 5 shows a preferred embodiment with a pawl 207 and ratchet 203. The pawl 207 can be engaged by pressure from a pawl-engaging spring 504 and a disengaged by pawl disengaging push-rod 505. The pawl-disengaging push rod may be operated mechanically or by a small relay which has its own battery and switch (not shown).

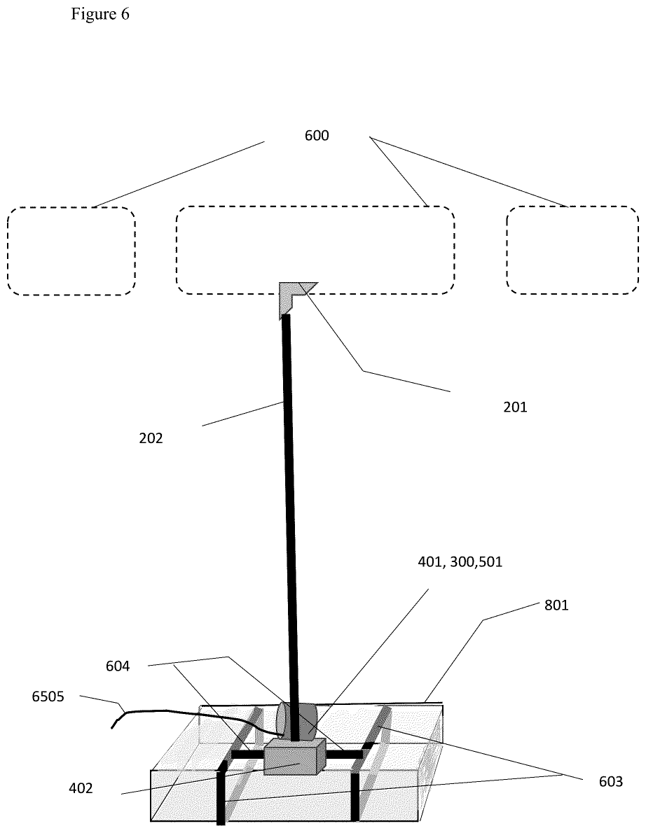

FIG. 6 shows a preferred embodiment with the hook 201 attached to a lip on a passenger aircraft overhead compartment 600 (not part of the invention). The web 202 reaches down to a luggage item 801 (not part of this embodiment) which is attached by means of a luggage lifter luggage harness 603, 604. The main luggage lifter mechanism (401, 300, 501) is attached to the harness 603, 604. A detachable, rechargeable battery 402 completes the luggage lifter ensemble.

The initiation of the action of the wound-up carbon nanotube fiber yarn torsion spring is done by the extended item 6505. This may be a mechanical flexible push rod-in-a flexible tube jacket which lifts the pawl 207 from the ratchet 203 by pushing on the pawl release 505. It may also be a switch at the end of a wire pair which activates a solenoid to raise the pawl release 505.

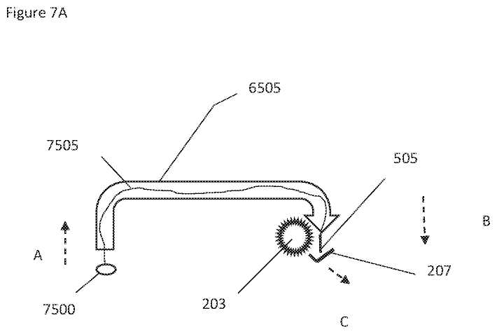

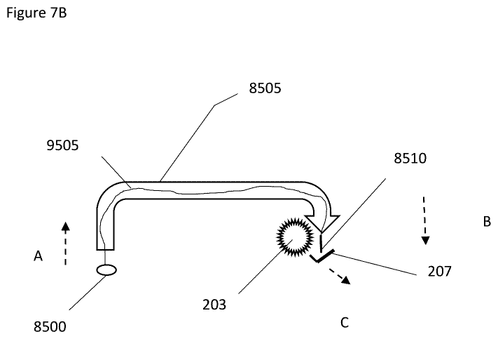

FIG. 7A shows a first preferred embodiment where a flexible jacket 6505 contains a flexible pushrod 7505. A finger pad 7500 is pressed in A to push out the pushrod 7505 to lift B the pawl release 505 to disengage C the pawl 505 from the ratchet 203 and allow the carbon nanotube fiber yarn torsion spring 501 (FIG. 2) to unwind and lift the traveler's luggage 602 (FIG. 6), not part of the invention. Not shown is a catch on the finger pad 7500 to keep the pawl release lifted

FIG. 7B shows a second preferred embodiment where an electrically insulated jacket 8505, which contains a wire pair 9505. A finger operated switch 8500 is closed, which operates a solenoid 8510 which lifts the pawl from the ratchet, activating the luggage lift.

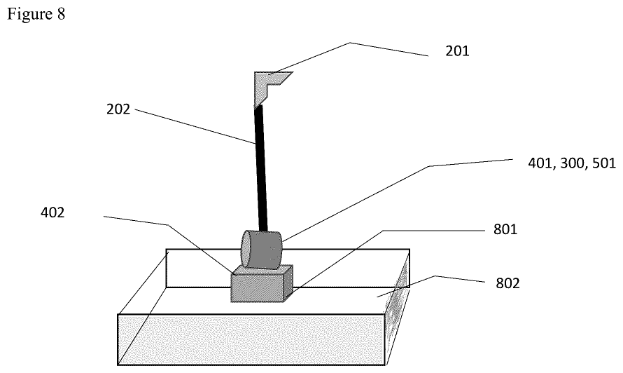

FIG. 8 FIG. 6 shows a preferred embodiment as a luggage lifter built into a luggage piece 801 with the hook 201 for attachment to a lip on a passenger aircraft overhead compartment (not part of the invention). The web 202 reaches down to a luggage piece 801, which is attached by attachment means 802 known in the arts, including, but not limited to, riveting to a backing plate. The main luggage lifter mechanism (401, 300, 501) is attached to the luggage piece 801 by attachment means 802. A detachable, rechargeable battery 402 completes the built-in luggage lifter ensemble.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means and methods. The following description is of the best mode presently contemplated for carrying out the invention. This description is not to be taken in a limiting sense but is merely made for the purpose of describing the general principles of and steps described in the specification. As one of ordinary skill in the art will readily appreciate from the disclosure of the present invention processes, machines, manufacture, compositions of matter, means, methods, steps, presently existing or later to be developed that perform substantially the same function or achieve substantially the same result as the corresponding embodiments described herein may be utilized according to the present invention.

What is claimed is:

1. A luggage-lifting apparatus for lifting and lowering a carry-on luggage into an overhead passenger aircraft overhead compartment, comprising:
a battery operated motor;
a removable battery;
a gear box;
a torsion spring wherein the torsion spring comprises carbon nanotube yarn;
a ratchet and pawl for allowing the carbon nanotube yarn torsion spring to be wound up by the gear reduced battery operated motor
a driving roller;
a passive roller;
a suspending web;
an attachment hook;
a luggage harness; and
a device for releasing the wound up carbon nanotube yarn torsion spring force.

2. The luggag-lifting apparatus of claim 1, further comprising:
a mechanical device for lifting the pawl from the ratchet, wherein a flexible pushrod inside a flexible jacket raises the pawl from the ratchet so that the energy of the wound-up carbon nanotube yarn torsion spring is released; and
a catch to enable the push rod to maintain the pawl in a raised condition.

3. The luggage-lifting apparatus of claim 1, further comprising:
an electrical device for lifting the pawl from the ratchet, wherein an electrical insulated jacket contains a wire pair electrical circuit which activates a solenoid, when the electrical circuit is switched on, which lifts the pawl from the ratchet so that the energy of the wound-up carbon nanotube yarn torsion spring is released; and
a switch which turns on the electrical circuit.

4. The luggage lifting apparatus of claim 1, further comprising:
a rechargeable battery able to recharge from a USB C cable or a lightning cable connection.

5. The luggage lifting apparatus of claim 1, further comprising;
a luggage piece with a built-in luggage lifter.
